(19) United States
(12) Patent Application Publication
(10) Pub. No.: US 2025/0105779 A1
(43) Pub. Date: Mar. 27, 2025

(54) WATERTIGHT SOLAR CANOPY SYSTEM AND METHOD

(71) Applicant: VCT Group Inc., Kitchener (CA)

(72) Inventors: Brian UNRAU, Kitchener (CA); Jesse REUSSER, Kitchener (CA); Lisa VINT, Kitchener (CA); John JOHNSTON, Kitchener (CA); Aaron JOBST, Kitchener (CA); Michael KRAUS, Kitchener (CA); Adam FRASER, Kitchener (CA); Luke KLASSEN, Kitchener (CA); Jeremy METZGER, Kitchener (CA); Mina AKBARY-ZHENG, Kitchener (CA); James LI, Kitchener (CA)

(21) Appl. No.: 18/898,164

(22) Filed: Sep. 26, 2024

Related U.S. Application Data
(60) Provisional application No. 63/585,577, filed on Sep. 26, 2023.

(51) Int. Cl. H02S 30/10; H02S 20/10; H02S 40/10

(52) U.S. Cl. CPC H02S 30/10; H02S 20/10; H02S 40/10

(57) ABSTRACT

A watertight solar canopy system and method is disclosed. The watertight solar canopy is a system of structurally integrated aluminum components and open channels running parallel and perpendicular to each other, between and below the solar panels, to create a watertight canopy for the entire solar PV surface. The solar canopy system comprises vertical rows of strapping channels, horizontal rows of panel troughs, mounts for array edges, caps and eaves mounts.

### CROSS REFERENCE TO RELATED APPLICATIONS

This application claims priority to and the benefit of U.S. Provisional Application Ser. No. 63/585,577, entitled “WATERTIGHT SOLAR CANOPY SYSTEM AND METHOD”, filed on Sep. 26, 2023, the disclosure of which is incorporated herein by reference in its entirety.

### BACKGROUND

The field of this disclosure relates to canopy structures, in particular to solar canopy structures.

A solar canopy or solar car port is a structure consisting of a solar array that harvests energy from the sun and also provides a sheltered space for a car to park underneath.

Precipitation is a big concern for solar canopies; water may fall on it, snow may build up on the flat surface and icicles may form. Accordingly, a solar canopy should keep precipitation from falling on, or creating a hazard to, the objects and surface below a solar canopy and control the precipitation as it descends off the canopy using methods that will last the life of the canopy.

There is a desire for a structure on the solar canopy that meets the functional and non-functional requirements to address waterproofing and precipitation concerns.

### BRIEF DESCRIPTION OF THE DRAWINGS

FIGS. 1A to 1C are perspective views illustrating an exemplary solar canopy.

FIGS. 2A to 2D are diagrams illustrating the strapping channels of the exemplary solar canopy.

FIGS. 3A to 3C are diagrams illustrating the strapping cap of the exemplary solar canopy.

FIGS. 4A to 4C are diagrams illustrating the panel trough of the exemplary solar canopy.

FIGS. 5A to 5D are diagrams illustrating an end cap and array edge of the solar canopy with horizontal main beams.

FIGS. 6A to 6C are diagrams illustrating an end cap of the solar canopy with vertical main beams.

FIGS. 7A to 7C are diagrams illustrating an exemplary trough of the exemplary solar canopy.

FIGS. 8A to 8C are diagrams illustrating an exemplary yoke and downspout of the exemplary solar canopy.

FIGS. 9A to 9C are diagrams illustrating a top cap of the exemplary solar canopy.

FIGS. 10A and 10B are diagrams illustrating an exemplary end trough of the exemplary solar canopy.

FIGS. 11A and 11B are diagrams illustrating an exemplary end downspout of the exemplary solar canopy.

FIGS. 12A to 12C are diagrams illustrating an exemplary expansion joint of the solar canopy.

FIGS. 13A to 13D are diagrams illustrating dimensions of exemplary solar canopy designs.

### SUMMARY

A watertight solar canopy system and method is disclosed. The watertight solar canopy (also known as an aqueduct) is a system of the structurally integrated aluminum components and open channels running parallel and perpendicular to each other, between and below the solar panels, to create a watertight canopy for the entire solar PV surface. The solar canopy system comprises vertical rows of strapping channels, horizontal rows of panel troughs, mounts for array edges, caps and eaves mounts.

### DETAILED DESCRIPTION

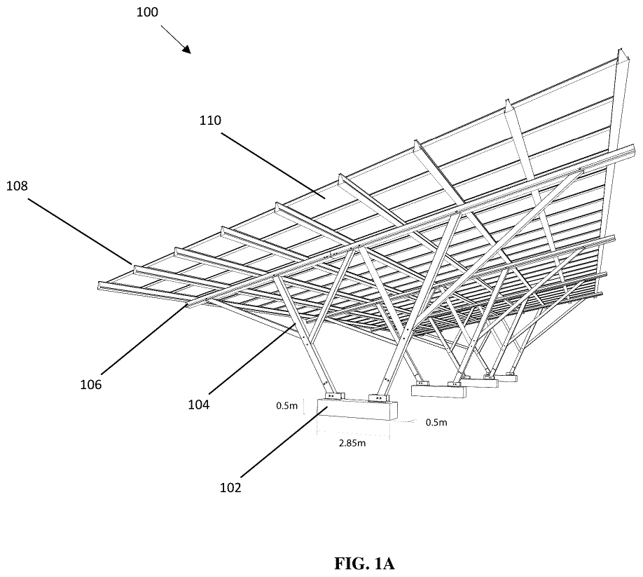

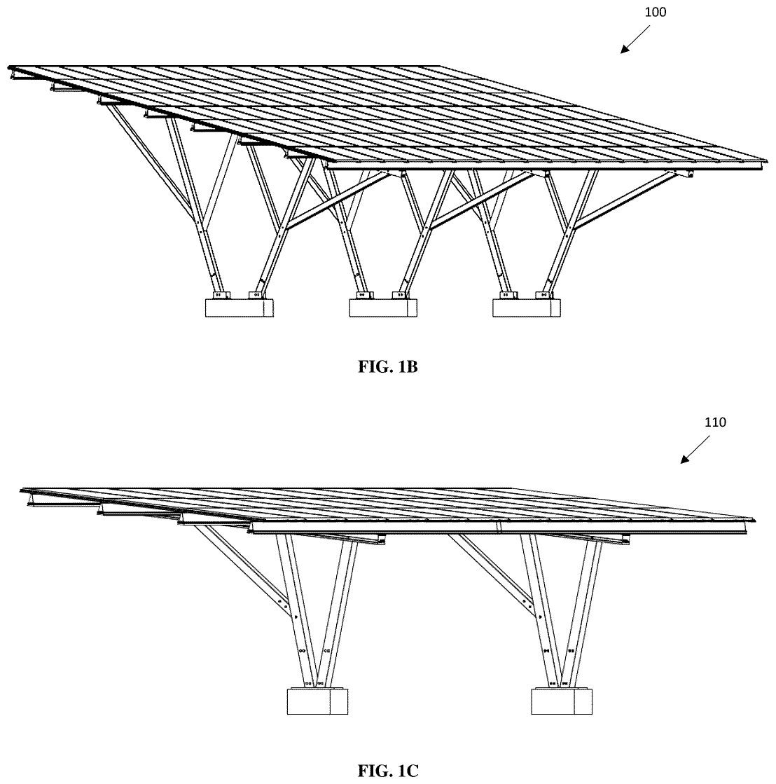

According to the disclosure, a solar canopy is disclosed where the structure addresses some of the precipitation concerns. FIGS. 1A to 1C are perspective views illustrating an exemplary solar canopy. According to FIG. 1A and FIG. 1B, solar canopy 100 consists of base 102, vertical struts 104, vertical beams 106 and horizontal beams 108. Solar panels 110 are installed on the solar canopy 100 facing the sun.

According to FIGS. 1A and 1B, dimensions of solar canopy 100 is X length by Y width by Z height. The base 102 has dimensions of 0.5 m width by 2.85 m length and 0.5 m height and is generally made of concrete.

FIG. 1C is a perspective view of an alternate solar canopy. According to FIG. 1C, alternate solar canopy 110 (also known as Hermes) is shown.

### Functional Requirements:

The follow is a list of some functional requirements for a solar canopy:
Keep the vast majority of precipitation from getting onto the objects or surface below the canopy.
Control and direct precipitation off the canopy into the desired location.
Maintain the visual aesthetics of a solar canopy
Prevent icicles from building up throughout the array
Prevent and avoid debris from clogging the system
Easy and fast to install.
Compatible with the majority of framed panels
Avoid structural weak points (i.e., hanging downspouts)
Facilitate the collection of water

### Non-Functional Requirements:

The follow is a list of non-functional requirements for a solar canopy:
Last for the life of the solar canopy system with no need for replacements or repair (i.e. no caulking, gaskets, or materials that can rust).
No joints in waterproof channels that could allow water infiltration
Have waterproof ability be independent of installation skill
Be cost-effective.
Be integrated into the racking of the canopy (where possible, the structural components are the water channels)
Minimally impede the bifacial performance of the solar photovoltaic (PV) system
Not use labour intensive installation methods (i.e., caulking/gaskets)

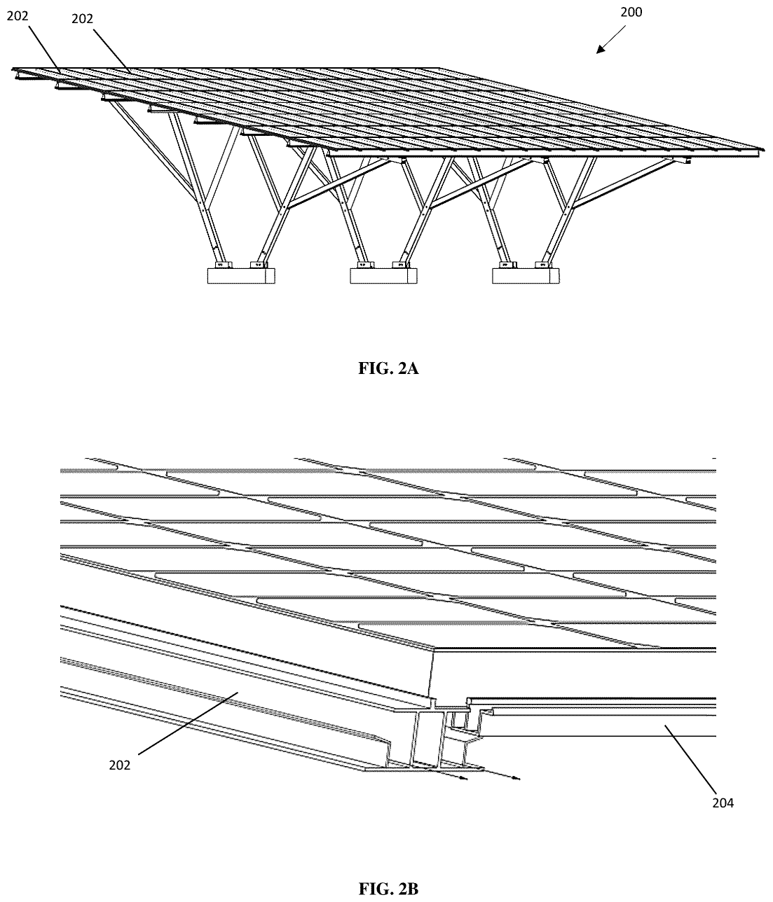

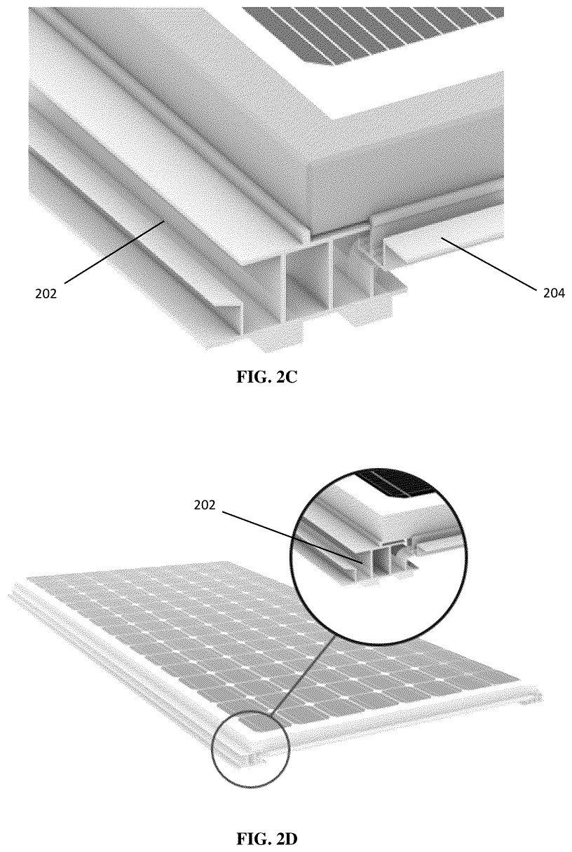

FIGS. 2A to 2D are diagrams illustrating strapping channels of the exemplary solar canopy. FIG. 2A is a perspective view of the exemplary solar canopy 200 with strapping channels 202. According to FIG. 2A, the strapping channel 202 runs in the direction of the fall line the entire length of the array. It runs between two rows of horizontally adjacent panels and has structural mounting points for the panels. On either side of the strapping channel there is a channel for water to collect as it falls off the side of the panel whereby water can then run along the fall line to the lower edge of the array.

FIG. 2B is a line drawing of the strapping channel showing the direction of water flow. FIG. 2B is a line drawing illustrating a strapping channel 202 of the solar canopy 200. According to FIG. 2B, there are two under-panel components, both of which are custom aluminum extrusions, the strapping channel 202 and the panel trough 204 which divert water away from the solar canopy 200.

FIGS. 2C and 2D are diagrams of close-up views of the strapping channel 202 also showing the direction of water flow. FIG. 2C is a close-up view illustrating a strapping channel 202 of the solar canopy 200. According to FIG. 2C, there are two under-panel components, both of which are custom aluminum extrusions, the strapping channel 202 and the panel trough 204. The strapping channel 202 (or channels) are shaped as water aqueducts to funnel water away from the top surface of the solar canopy 200.

According to FIG. 2C, the panel trough 204 runs perpendicular to the strapping channel 202 (and the fall line) between the two vertically adjacent panels. It is mechanically locked into place below the panel and above the water channel of the strapping channel.

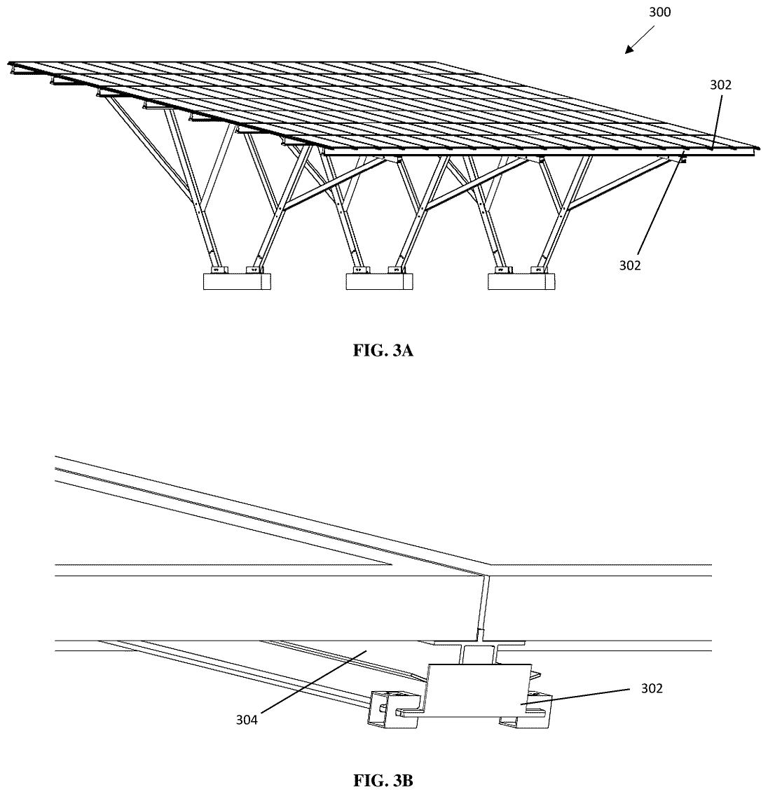

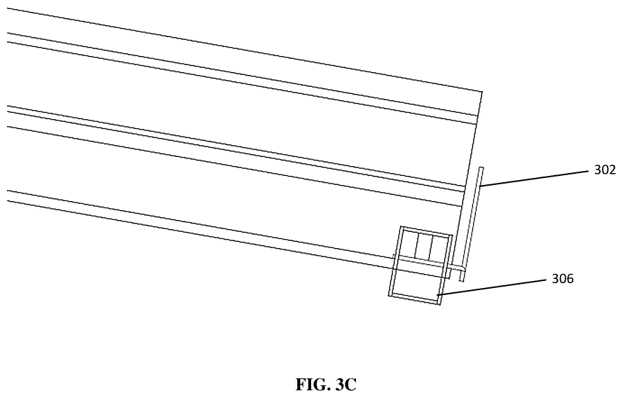

FIGS. 3A to 3C are diagrams illustrating the strapping cap of the exemplary solar canopy. FIG. 3A is a perspective view of a solar canopy 300 with a plurality of strapping caps 302. FIG. 3B is a close-up view of the strapping cap 302. According to FIG. 3B, strapping cap 302 connects at the ends of strapping channel 304.

FIG. 3C is a left-side view of the solar canopy with the strapping cap. According to FIG. 3C, strapping cap 302 is shown connected to widget 306.

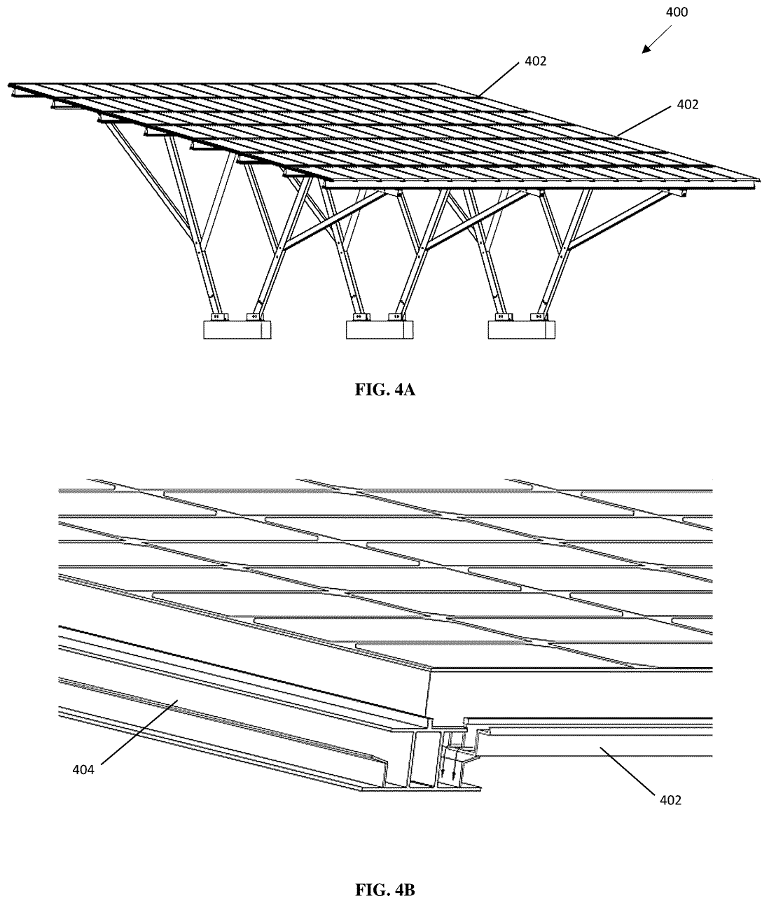

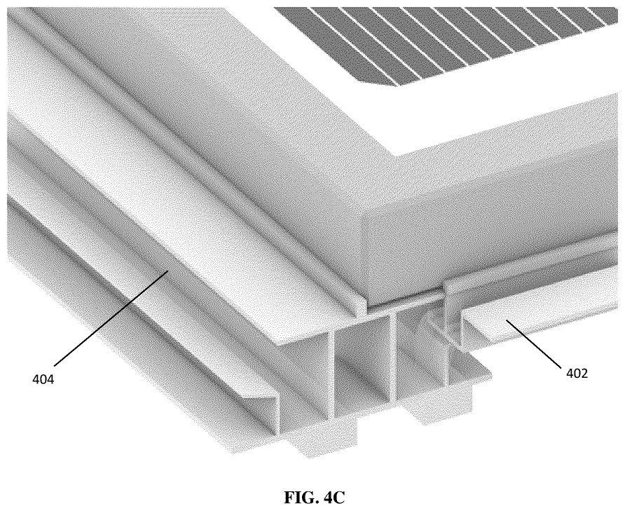

FIGS. 4A to 4C are diagrams illustrating the horizontal panel trough of the exemplary solar canopy. FIG. 4A is a perspective view of solar canopy 400 with a plurality of horizontal panel troughs 402. According to FIG. 4A, the horizontal panel trough 402 runs between each pair of vertically adjacent panels and extends the length from one strapping channel to the next.

FIG. 4B is a line drawing of the horizontal panel trough. According to FIG. 4B, on either side of panel trough 402 there is a channel for water to collect as it falls from the lower edge of the panel. It can then run in either direction (i.e., horizontal to the fall line) until it reaches a strapping channel 404. Water would then fall from the end of the panel trough 402 into the open channel of the strapping channel 404. Water will then flow along the fall line to the lower edge of the array.

FIG. 4C is a close-up view of the panel trough. According to FIG. 4C, solar canopy 400 consists of a network of strapping channels 404 running in perpendicular and a network of panel troughs 402 in the parallel direction, all leading towards a central trough and downspout. This network consists of two main parts, the under-panel components, and the array-edge components.

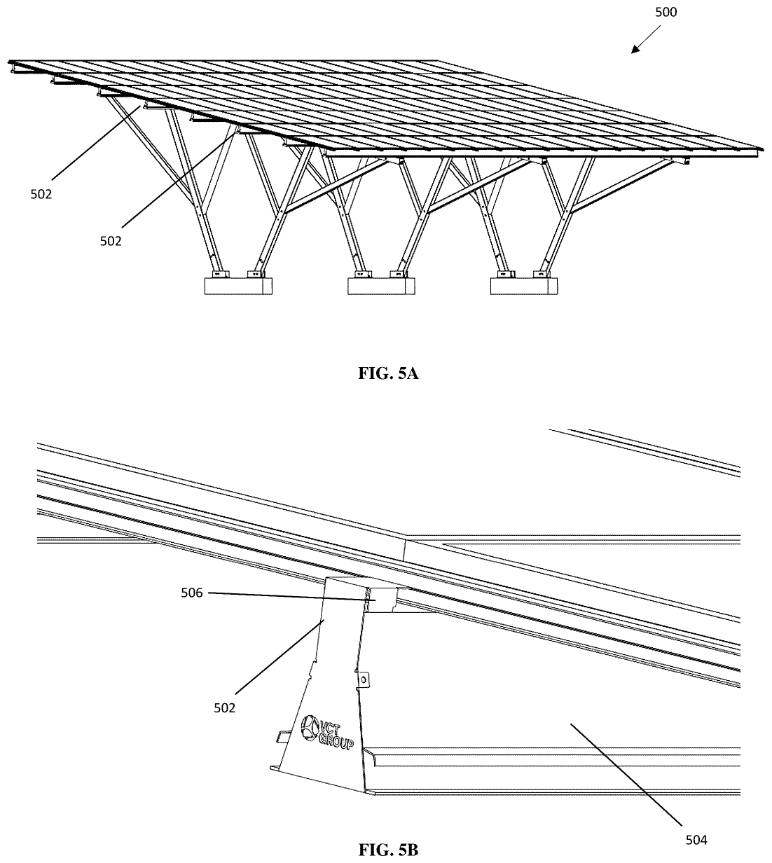

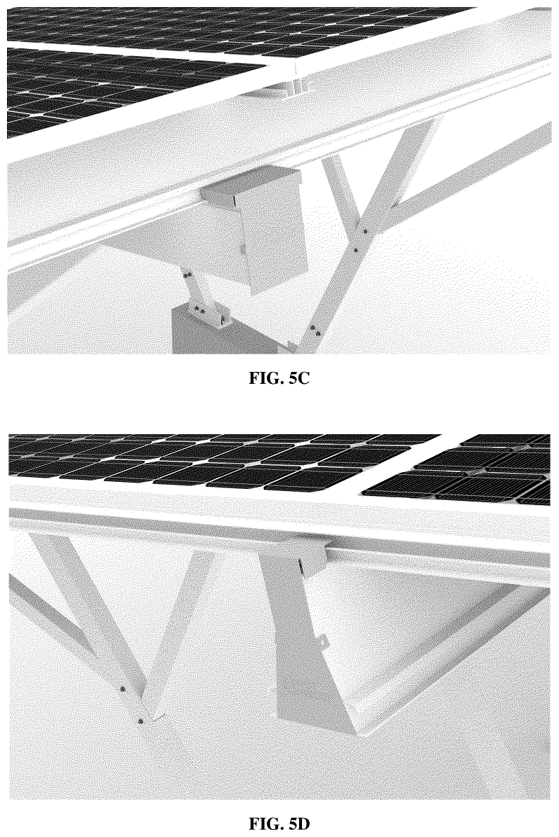

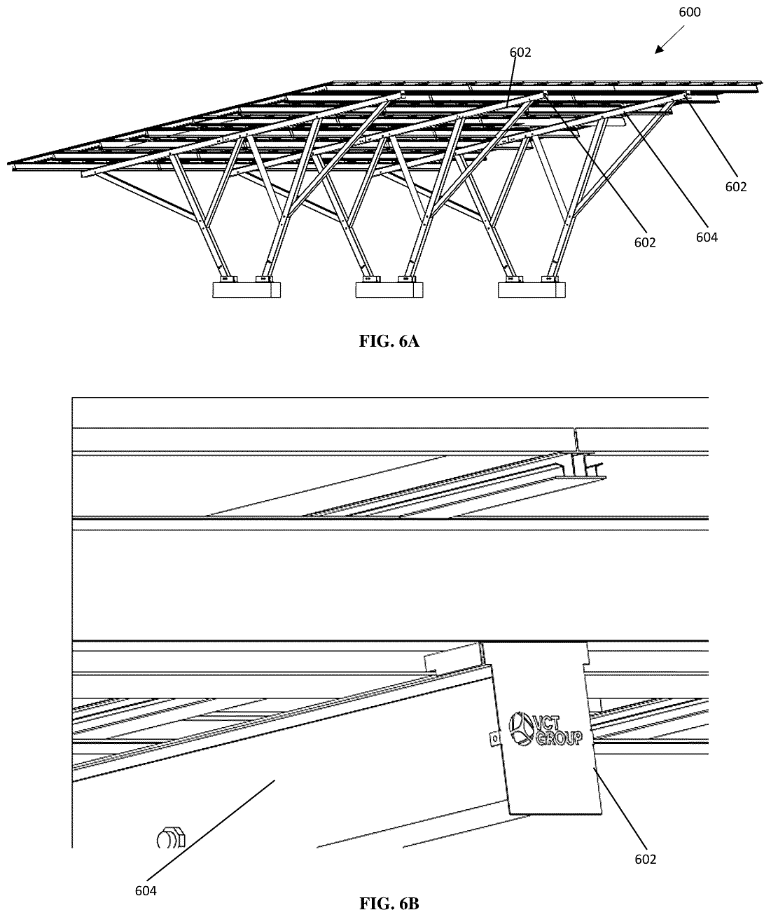

FIGS. 5A to 5D are diagrams illustrating an end cap and array edge of the solar canopy with horizontal main beams. According to FIGS. 5A to 5D, the end cap and array edge of the solar canopy is shown. The array-edge components depend on what the model of the canopy is. Due to differing geometry, different styles of water channeling are needed. However, there are some components that remain consistent in all models.

FIG. 5A is a perspective view of the end cap of the exemplary solar canopy. According to FIG. 5A, solar canopy 500 is shown having end cap 502 on the main beams. FIG. 5B is a line drawing illustrating a close-up view of the array-edge and end cap. FIG. 5C and FIG. 5D are close-up views of the array edge and end cap.

According to FIG. 5B, the array-edge features that will remain consistent are: the main beam endcaps 506, the main beam 504, and purlin endcaps 502. The main beam 504 and purlin endcaps 502 are covers that close the open end of the main beam 504 and purlins respectively on both the low and high edges of the array. This is done to prevent precipitation from getting inside the beams which could lead the water to a bolt hole or joint. The main beam 504 and purlin end caps 502 has an upper portion that extends over the top and sides of the mounting points on the beams to prevent precipitation from getting on top of the beams which could lead the water to a joint or bolt hole.

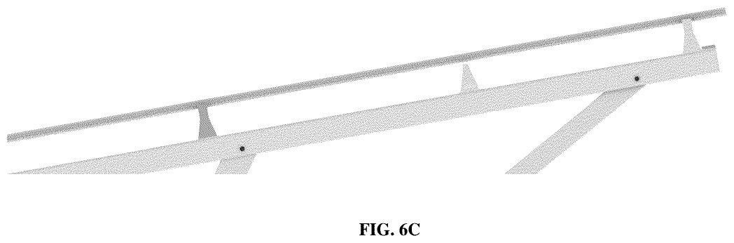

FIGS. 6A to 6C are diagrams illustrating an end cap of the solar canopy with vertical main beams. According to FIG. 6A, solar canopy 600 comprises of a plurality of vertical beams 604 having a vertical end cap 602. FIG. 6B is a line drawing of a close-up view of the end cap and vertical main beam.

FIG. 6C is a right-side view illustrating the main beam on the solar canopy. According to FIG. 6, the main beam end design isn't a component but a design choice to terminate the main beam such that none of the main beam is exposed to direct vertical precipitation. This is done to lower the chance of precipitation getting through the main beam end cap design and still into the main beam.

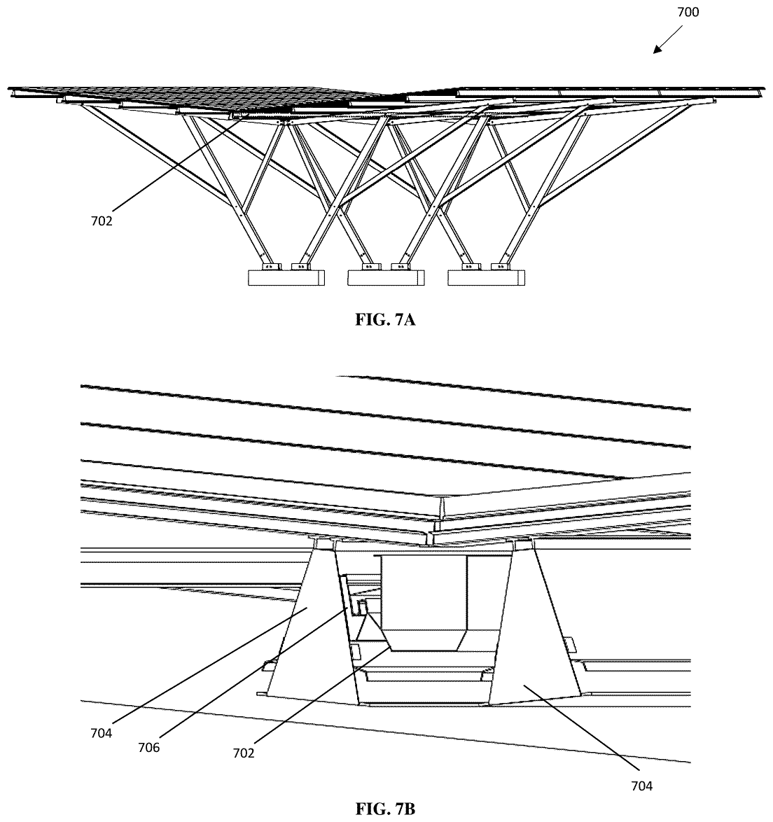

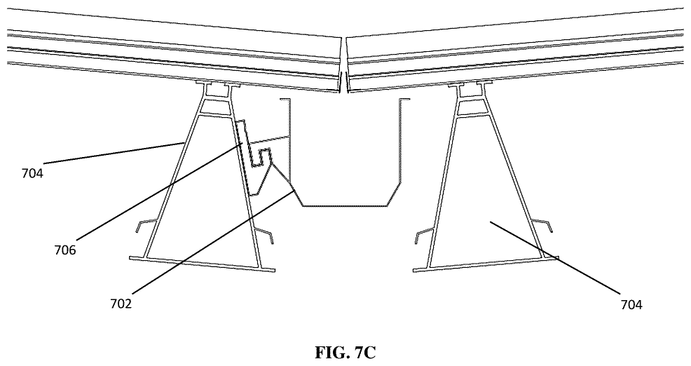

FIGS. 7A to 7C are diagrams illustrating an exemplary trough of the exemplary solar canopy. FIG. 7A is a perspective view of an exemplary trough. According to FIG. 7A, solar canopy 700 is shown with a Pegasus trough 702.

FIGS. 7B and 7C are close-up views of the exemplary trough. According to FIGS. 7B and 7C, Pegasus trough 702 is shown connected to trough mount 706. Pegasus trough 702 is placed between main beams 704 underneath the solar canopy where water will flow into.

According to FIGS. 7A-7C, the array-edge features will differ based on model of the solar canopy. For example, the Pegasus trough, Apollo cap, Heliostation eaves mount, and Heliostation expansion joint. The Pegasus trough is a custom aluminum extrusion located on the low (inner) array edge junction of the Pegasus style canopies. It is mechanically fastened to the underside of the strapping and runs the entire length of the array perpendicular to the fall line. Precipitation that falls off the lowest panels or out the low end of the strapping channel runs into the large channels on the Pegasus trough, which then directs water using slope, to various downspouts throughout the array as needed. The downspouts are traditional industry standard downspouts. There is a geometric feature (which is designed to work with a built-in slope) on the top of the Pegasus trough that fits in the middle of the lowest panels, to limit the incursion of snow and leaves into the Pegasus trough.

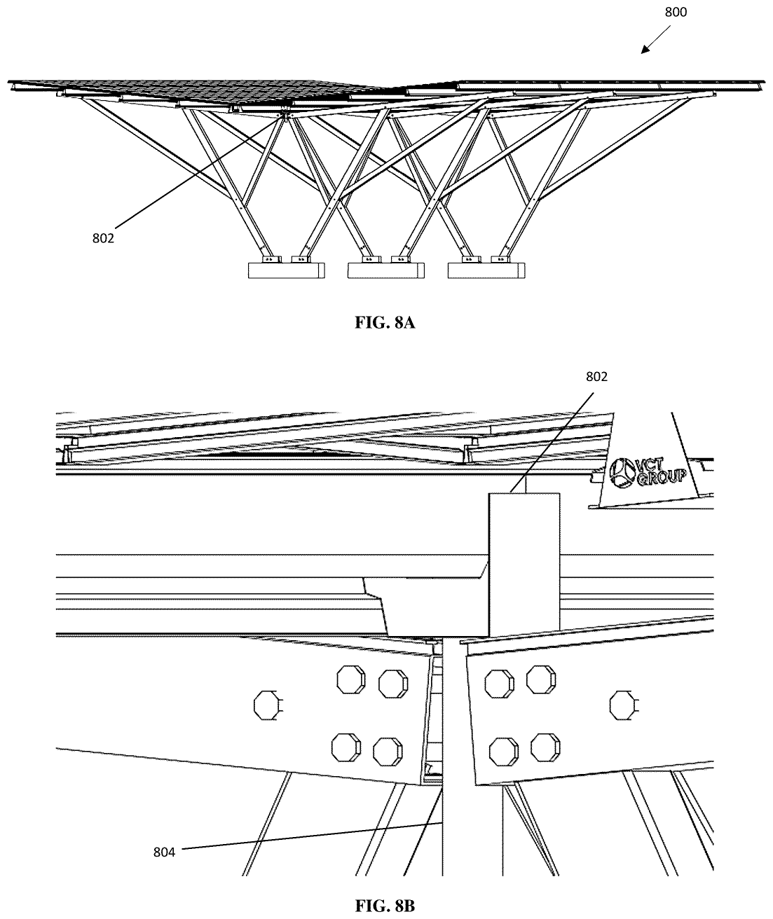

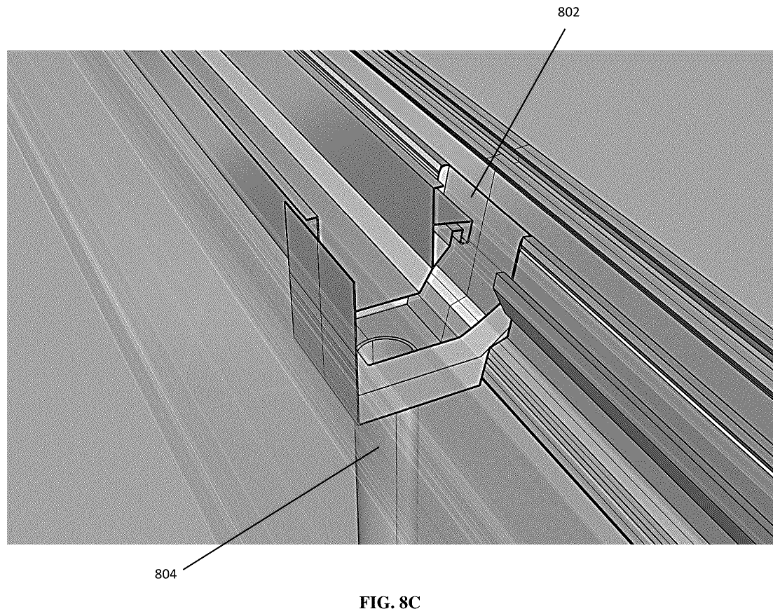

FIGS. 8A to 8C are diagrams illustrating an exemplary yoke and downspout of the exemplary solar canopy. FIG. 8A is a perspective view of an exemplary yoke. According to FIG. 8A, solar canopy 800 is shown with Pegasus yoke 802. FIGS. 8B and 8C are close-up views of the exemplary yoke and downspout. According to FIGS. 8B and 8C, Pegasus yoke 802 is shown connected to downspout 804. Downspout 804 is made of aluminum or polyvinyl chloride (PVC) plastic.

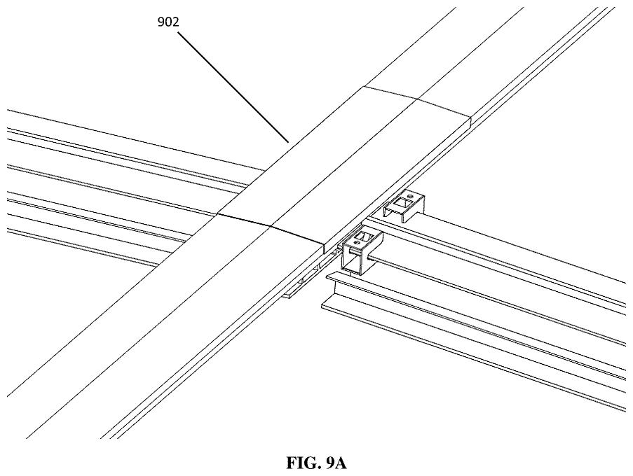

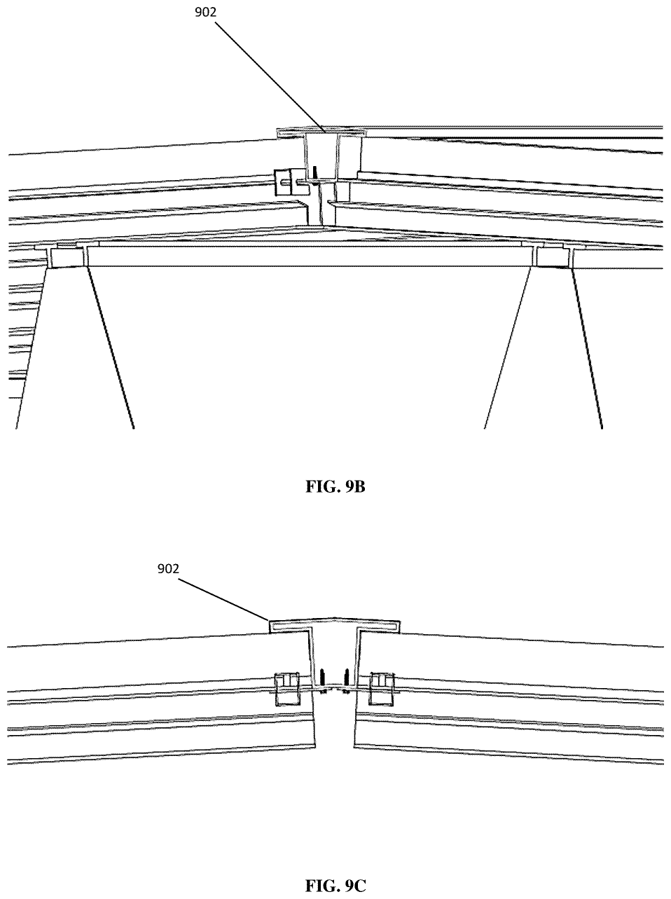

FIGS. 9A to 9C are diagrams illustrating a top cap of the exemplary solar canopy. FIGS. 9A and 9B are perspective views of a top cap. According to FIGS. 9A and 9B, top cap 902 (also referred to as an Apollo cap) connects two separate solar canopies or solar arrays together. FIG. 9C is a close-up view of the top cap. According to FIG. 9C, top cap 902 (e.g., Apollo cap) is shown in a close-up view connected two solar canopies.

According to FIGS. 9A to 9C, Apollo cap 902 is a custom aluminum extrusion located at the high (inner) array edge junction of the Apollo style canopies. It is mechanically fastened to the strapping and sits above the panel plane and runs the entire length of the canopy perpendicular to the fall line. Precipitation falls onto the Apollo cap and runs onto the top plane of the solar panels to which it can be dealt with by the under-panel components. Lap joints are utilized to prevent precipitation from entering at that location.

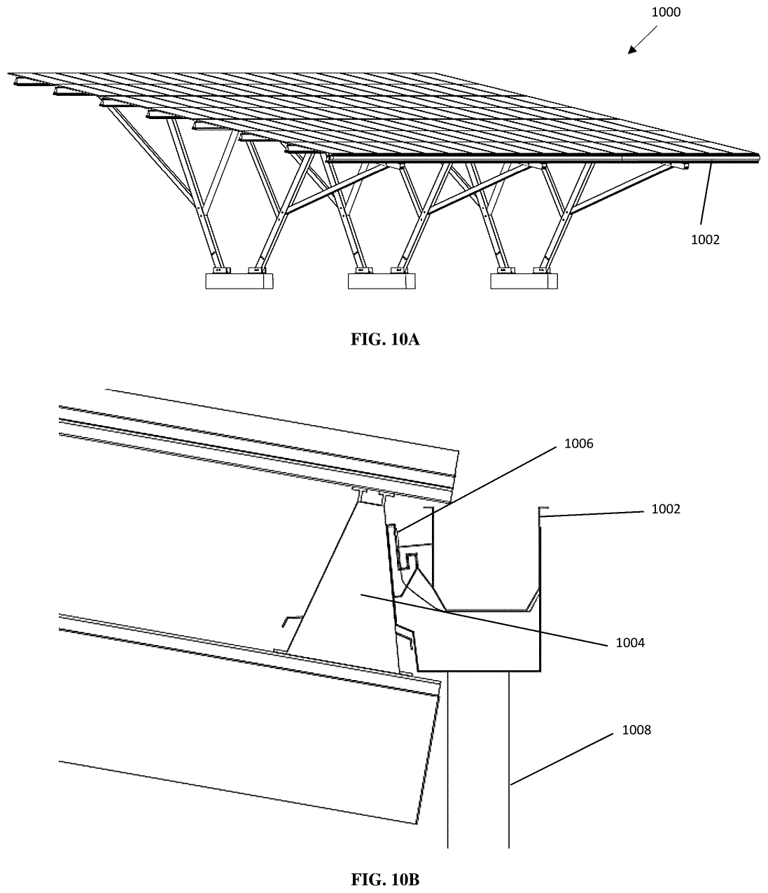

FIGS. 10A and 10B are diagrams illustrating an exemplary end trough of the exemplary solar canopy. FIG. 10A is a perspective view of the end trough. According to FIG. 10A, solar canopy 1000 is shown with end trough 1000. End trough 1000 can support different solar canopy models including Mercury, Hermes and Apollo.

FIG. 10B is a left-side view of the exemplary end trough. According to FIG. 10B, end trough 1002 is shown connected to main beam 1004 by end trough mount 1006. End trough 1002 is also connected to end downspout 1008 to divert water away from solar canopy 1000.

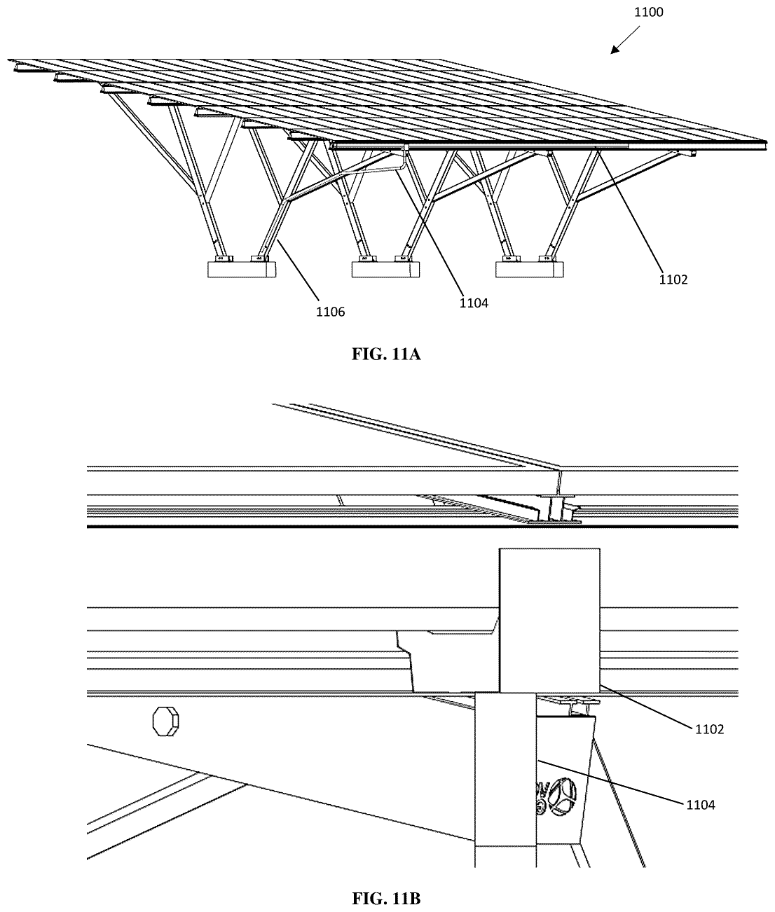

FIGS. 11A and 11B are diagrams illustrating an exemplary end downspout of the solar canopy. FIG. 11A is a perspective view of the end downspout. According to FIG. 11A, solar canopy 1100 is shown having an end trough 1102. Connected to the end trough 1102 is end downspout 1104 which may run down to the ground along vertical struts 1106.

FIG. 11B is a close-up view of end downspout. According to FIG. 11B, end trough 1102 is shown connected to end downspout 1104. End downspout 1102 is made of aluminum or polyvinyl chloride (PVC) plastic.

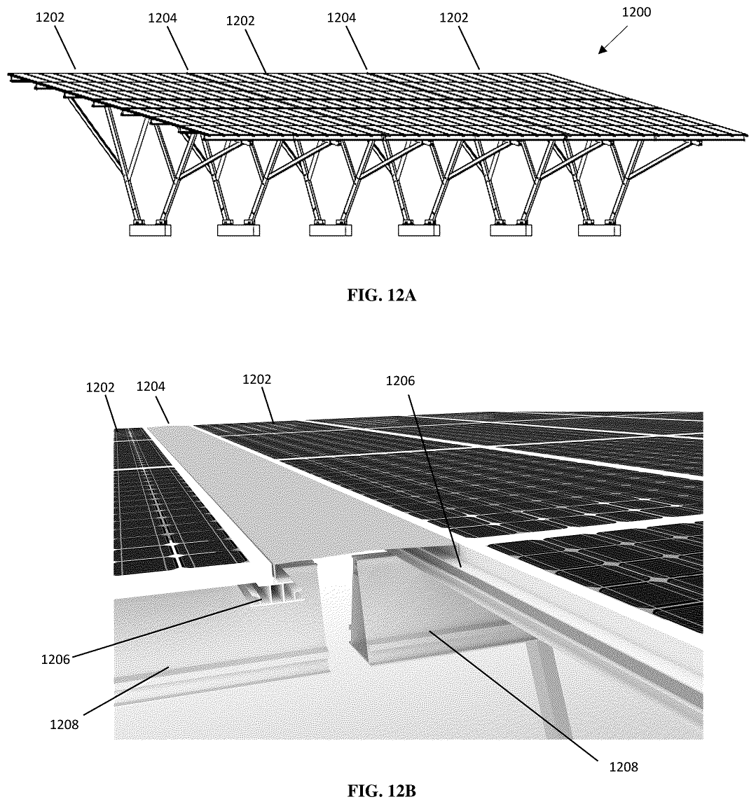

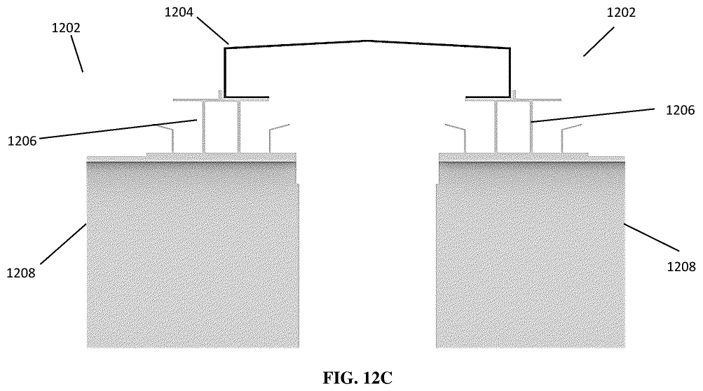

FIGS. 12A to 12C are diagrams illustrating an exemplary expansion joint of the solar canopy. FIG. 12A is a perspective view of an exemplary expansion joint connecting multiple solar arrays. According to FIG. 12A, solar canopy 1200 is shown consisting of multiple solar arrays 1202. Solar arrays 1202 is shown connected together with expansion joint 1204 (e.g., Heliostation expansion joint). Expansion joint 1204 bridges the gap and connects two or more solar arrays 1202.

FIG. 12B is a close-up view of the exemplary expansion joint. FIG. 12C is a right-side view illustrating the expansion joint (e.g., Heliostation expansion joint) of the solar canopy. According to FIG. 12B, solar arrays 1202 are shown connected to expansion joint 1204. Expansion joint 1204 is shown attached to solar array panel trough 1206. Solar array 1202 is also shown mounted on main beams 1208. According to FIG. 12C, expansion joint 1204 is shown connecting solar arrays 1202. Solar arrays 1202 is connected to main beams 1208 via solar array panel trough 1206.

According to FIGS. 12B and 12B, the Heliostation expansion joint is an aluminum sheet metal cover that bridges the mechanical isolation gap that is required in some solar canopies. It runs the length of the canopy parallel to the fall line and essentially functions as a dummy panel but allows for mechanical expansion and contraction. The Heliostation expansion joint is attached to one strapping channel and bridges the gap to the other where it is not attached, the shape allowing for bending within the joint. Water that falls onto the Heliostation expansion joint is directed to either side of the joint and into the strapping channel adjacent to it. Lap joints are utilized to connect lengths of the expansion joint.

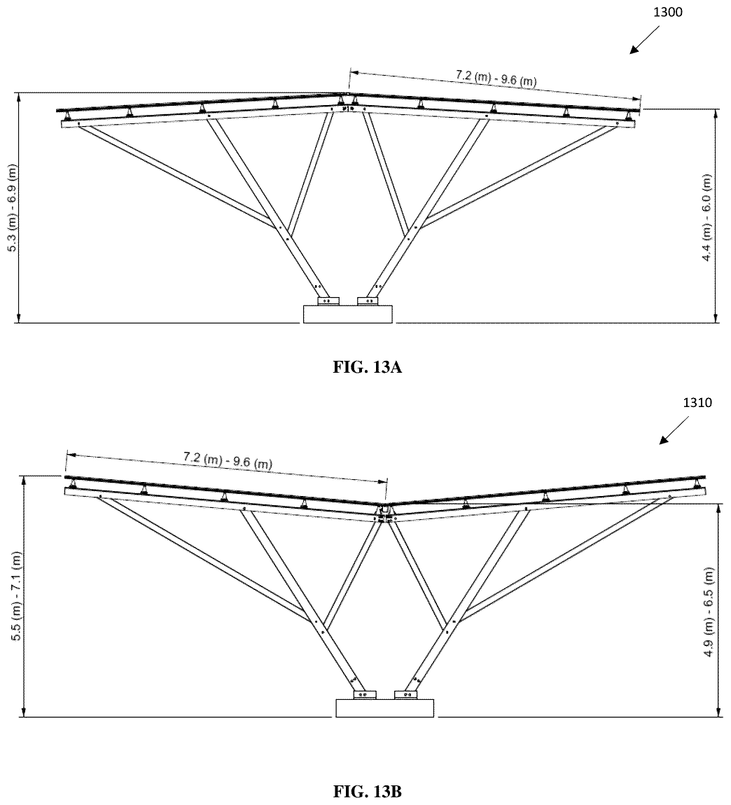

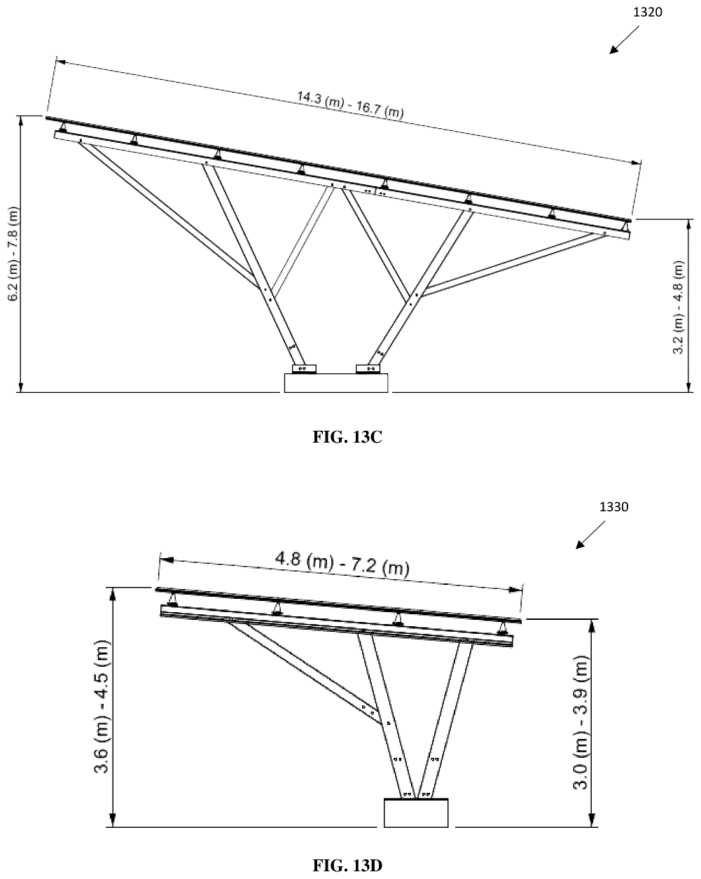

FIGS. 13A to 13D are diagrams illustrating dimensions of exemplary solar canopy designs. FIG. 13A is a diagram illustrating the preferred solar canopy embodiment 1300 (e.g., Apollo) with width of 7.2 m-9.6 m for the solar array and a height of 4.4 m to 6.9 m from the ground.

FIG. 13B is a diagram illustrating an alternate solar canopy embodiment 1310 (e.g., Pegasus) with width of 7.2 m-9.6 m for the solar array and a height of 4.9 m to 7.1 m from the ground.

FIG. 13C is a diagram illustrating an alternate solar canopy embodiment 1320 (e.g., Mercury) with width of 14.3 m-16.7 m for the solar array and a height of 3.2 m to 7.8 m from the ground.

FIG. 13D is a diagram illustrating an alternate solar canopy embodiment 1330 (e.g., Hermes) with width of 4.8 m-7.2 m for the solar array and a height of 3.0 m to 4.5 m from the ground.

### Alternate Solutions

The following table highlights alternate solutions and why they don't address the problem sufficiently:

| Solution Type | Observations |
|---|---|
| Full under panel decking | This does a few things well. The waterproofing, clog-resistance, lifespan, |
| | and icicle prevention are achieved. However, it doesn't allow for any |
| | bifacial energy production, and almost completely prevents the canopy |
| | from maintaining the aesthetics of a solar canopy. |
| | Bi-facial gain can account for up to a 10% performance increase when |
| | compared to the single sided performance of panels. This is a |
| | considerable compromise when considering the ramifications of 10% less |
| | energy production. Not maintaining the aesthetics of a solar canopy |
| | (because the decking will nearly hide the entire array) is likely a problem |
| | for most clients. |
| Gaskets or Caulking | Gaskets or caulking address most of the problem and requirements but |
| | neglect one very important aspect of the problem statement “ . . . using |
| | methods that will last the life of the canopy.” This is a huge drawback of |
| | the solution as they will require maintenance and a full overhaul (One |
| | company quotes 10-year life on their gasketing system). This would likely |
| | require full removal of panels, removal of old gaskets/caulking, |
| | reinstallation of gaskets/caulking, and reinstallation of panels. Solar |
| | projects typically need very little maintenance to perform, so having the |
| | water proofing system be the weak point is a huge hole in this solution |
| | to the problem. There is also a chance that this system will leak from day |
| | 1 because of improper installation. |
| Special Rails with gaskets | This solution does better than gaskets/caulking alone as it will likely |
| | extend the lifespan of the carport. However, gaskets will wear out over |
| | time and are susceptible to incorrect installation and this solution is |
| | subject to the same critiques as gaskets/caulking alone. |
| Channeling in one | This solution addresses a lot of the problem, but it doesn't address one |
| direction | of the main infiltration points for precipitation to enter the system. This |
| | infiltration point (on short edges of the panels parallel to the fall line) is |
| | less significant than the long edge infiltration point, but still will allow a |
| | significant amount of precipitation into the system. If this infiltration |
| | point is filled with gaskets/caulking, it will help to address the problem |
| | better, but is then subject to the downfalls of gaskets/caulking |
| | mentioned above. |
| Steel | The use of steel in any of the above solutions fails to “ . . . us[e] methods |
| | that will last the life of the canopy” outlined in the problem statement |
| | above. Steel even when treated (painted, coated, galvanized, etc.) is still |
| | subject to rust after several years of use. One company quotes a 10-year |
| | life on the galvanization of their system before the need to re-treat the |
| | steel. As the coating wears down, the steel can begin to rust which has |
| | poor aesthetic ramifications as well as performance. The expansion and |
| | material wear from corrosion could cause failure points in the water |
| | proofing system. Because of this, the steel will likely need to be |
| | retreated within the life of the canopy resulting in high costs to maintain |
| | good waterproof performance and aesthetics. |

According to the disclosure, the solar canopy components are made of extruded or manufactured sheet aluminum.

According to the disclosure, embodiments of the solar canopy design also include troughs leading into troughs all under the panel plane. This is known as the Pegasus trough or a design where the panel trough feeds into the strapping and into the eaves. Existing solutions try to keep the water above the panels by trying to plug the gaps between the panels (in both directions) to prevent water from getting underneath the panels.

Furthermore, the solar canopy design also allows the water to get below the plane of the panels which minimizes or eliminates lap joints.

Further embodiments of the disclosure could include a custom single network of channels whereby a single large grid like trough that would all be connected and lead to the bottom edge of the array.

According to the disclosure, a solar canopy system configured to collect solar energy is disclosed. The solar canopy system comprises a frame configured to support a plurality of solar panels. The frame further comprises a plurality of vertical beams and a plurality of horizontal beams. The solar canopy further comprises a plurality of base modules securely mounted to the ground, a plurality of vertical trusses connecting the base modules to the frame, a plurality of main beams to support the frame and a water diversion system configured to channel and divert water away from the solar canopy.

According to the disclosure, the water diversion system further comprises a plurality of vertical or horizontal strapping channels connecting the solar panels, a plurality of panel troughs and yokes connecting to the edge of the frame, and end trough and end downspout to divert water to the ground. The frame is angled at an angle for the solar panels to collect solar energy from the sun and enable water to be diverted away from the solar canopy and the solar canopy is configured to be watertight.

According to the disclosure, the solar canopy system further comprises a plurality of strapping caps at the ends of the strapping channels. The main beams consists of vertical main beams deployed in a vertical configuration or horizontal main beams deployed in a horizontal configuration. The main beams further comprise end caps.

According to the disclosure, the panel troughs of the solar canopy further comprise a trough mount to connect the panel troughs to the side of the main beam. The end downspout of the solar canopy is configured to connect the vertical truss to the ground.

According to the disclosure, the solar canopy system further comprise expansion joints to connect two or more solar panel arrays. The solar canopy system and water diversion system components are made of extruded aluminum or manufactured sheet aluminum. Furthermore, the solar canopy is angled at a range of 3 degrees to 10 degrees to enable water flow.

According to the disclosure, a water diversion system configured to channel and divert water away from solar panels of a solar canopy is disclosed. The water diversion system further comprises a plurality of vertical or horizontal strapping channels connecting to solar panels, a plurality of panel troughs and yokes connecting to the edge of the frame of the solar canopy, and an end trough and end downspout to divert water to the ground.

According to the disclosure, the frame of the water diversion system is angled at an angle for the solar panels to collect solar energy from the sun and enable water to be diverted away from the solar canopy and the water diversion system is configured to be watertight.

According to the disclosure, the water diversion system further comprises a plurality of strapping caps at the ends of the strapping channels. The panel troughs of the water diversion system further comprise a trough mount to connect the panel troughs to the side of the main beam. The end downspout of the water diversion system is configured to connect to a vertical truss of the solar canopy and divert water to the ground.

According to the disclosure, the water diversion system further comprises expansion joints to connect two or more solar panel arrays. Furthermore, the water diversion system components are made of extruded aluminum or manufactured sheet aluminum.

While some embodiments or aspects of the present disclosure may be implemented in fully functioning mechanical, electrical and electrical-mechanical systems, other embodiments may be considered.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The specific embodiments described above have been shown by way of example and understood is that these embodiments may be susceptible to various modifications and alternative forms. Further understood is that the claims are not intended to be limited to the forms disclosed, but to cover all modifications, equivalents, and alternatives falling within the spirit and scope of this disclosure. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, various changes and modifications in form, material, workpiece, and fabrication material detail may be made, without departing from the spirit and scope of the present disclosure, as set forth in the appended claims, as may be apparent to those of ordinary skill in the art, are also encompassed by the present disclosure.

What is claimed is:

1. A solar canopy system configured to collect solar energy, the system comprising;
a frame configured to support a plurality of solar panels, the frame further comprising:
a plurality of vertical beams; and
a plurality of horizontal beams;
a plurality of base modules securely mounted to the ground;
a plurality of vertical trusses connecting the base modules to the frame;
a plurality of main beams to support the frame; and
a water diversion system configured to channel and divert water away from the solar canopy, the water diversion system further comprising:
a plurality of vertical or horizontal strapping channels connecting the solar panels;
a plurality of panel troughs and yokes connecting to the edge of the frame; and
an end trough and end downspout to divert water to the ground;
wherein the frame is angled at an angle for the solar panels to collect solar energy from the sun and enable water to be diverted away from the solar canopy;
wherein the solar canopy is configured to be watertight.

2. The solar canopy system of claim 1 further comprising a plurality of strapping caps at the ends of the strapping channels.

3. The solar canopy of claim 1 wherein the main beams are vertical main beams deployed in a vertical configuration or horizontal main beams deployed in a horizontal configuration.

4. The solar canopy system of claim 1 wherein the main beams further comprise end caps.

5. The solar canopy system of claim 1 wherein the panel troughs further comprise a trough mount to connect the panel troughs to the side of the main beam.

6. The solar canopy system of claim 1 wherein the end downspout is configured to connect the vertical truss to the ground.

7. The solar canopy system of claim 1 further comprising expansion joints to connect two or more solar panel arrays.

8. The solar canopy system of claim 1 wherein the solar canopy system and water diversion system components are made of extruded aluminum or manufactured sheet aluminum.

9. The solar canopy system of claim 1 wherein the solar canopy is angled at a range of 3 degrees to 10 degrees to enable water flow.

10. A water diversion system configured to channel and divert water away from solar panels of a solar canopy, the water diversion system further comprising:
a plurality of vertical or horizontal strapping channels connecting to the solar panels;
a plurality of panel troughs and yokes connecting to the edge of the frame of the solar canopy;
an end trough and end downspout to divert water to the ground;
wherein the frame is angled at an angle for the solar panels to collect solar energy from the sun and enable water to be diverted away from the solar canopy;
wherein the water diversion system is configured to be watertight.

11. The water diversion system of claim 10 further comprising a plurality of strapping caps at the ends of the strapping channels.

12. The water diversion system of claim 10 wherein the panel troughs further comprising a trough mount to connect the panel troughs to the side of the main beam.

13. The water diversion system of claim 10 wherein the end downspout is configured to connect to a vertical truss of the solar canopy and divert water to the ground.

14. The water diversion system of claim 10 further comprising expansion joints to connect two or more solar panel arrays.

15. The water diversion system of claim 10 wherein the water diversion system components are made of extruded aluminum or manufactured sheet aluminum.
